(19) United States
(12) Patent Application Publication
(10) Pub. No.: US 2013/0201780 A1
(43) Pub. Date: Aug. 8, 2013

(54) CENTRIFUGAL CONCRETE MIXER

(71) Applicant: SHU-HUNG LIAO, Taichung City (TW)

(72) Inventor: SHU-HUNG LIAO, Taichung City (TW)

(21) Appl. No.: 13/367,366

(22) Filed: Feb. 6, 2012

(51) Int. Cl. B28C 5/16

(52) U.S. Cl. 366/65

(57) ABSTRACT

A centrifugal concrete mixer includes a base frame, a mixing drum provided on the base frame, a transmission means and two stirring pieces. The transmission means has a power device driving a transmission shaft to rotate at a speed of 60 rpm to 600 rpm. One end of the transmission shaft penetrates into the mixing drum. A waterproof unit is provided between the transmission shaft and the mixing drum. The stirring pieces are assembled on the transmission shaft in the mixing drum. The stirring piece is formed into a plate. An outer surface of each stirring piece relative to its rotating direction is formed into an inclined surface. The outer end of each stirring piece is provided with an auxiliary stirring portion to face the inner surface of the mixing drum. The rotation of the stirring piece generates a centrifugal force to stir the concrete containing gravels.

### BACKGROUND OF THE INVENTION

1. Field of the Invention

The present invention relates to a concrete mixer, and in particular to a centrifugal concrete mixer, which employs a centrifugal force to mix the concrete so as to change the traditional way of using gravity to mix concrete in a rotating drum.

2. Description of Prior Art

Most of the buildings are often constructed by concrete. The concrete is made by mixing cement, sandstones and water in a proper ratio. According to prior art, U.S. Pat. No. 5,137,366 discloses a concrete mixer as shown in FIG. 1. The concrete mixer employs a motor to drive a belt pulley set 91. The belt pulley set 91 causes a cylinder 92 to rotate. The cement, sandstone and water to be mixed are put in the cylinder 92. When the cylinder 92 rotates, the cement, sandstone and water are mixed in the rotating cylinder 92 by gravity, thereby forming the mixed concrete. However, such a conventional concrete mixer is complicated in structure, bulky in volume, and dangerous to feed materials. Further, the mixing efficiency and the quality of the mixed concrete are not good, so that there is still room for improvement in this conventional concrete mixer.

Further, U.S. Pat. No. 6,386,747 discloses an apparatus for mixing cement, which is a previous invention of the present Inventor. As shown in FIG. 2, in this patent, a mixing drum 94 is provide on a frame 93. The underside of the frame 93 is provided with a transmission means 95. The transmission means 95 drives a mixing arm 96 to rotate. The mixing arm 96 is put in the mixing drum 94. The transmission means 95 is configured to convert the high rotation speed of the motor into a low rotation speed by a large torque, thereby compulsorily mixing the cement. However, such an apparatus has a high cost but a low mixing efficiency. Further, such an apparatus can mix cement only but cannot mix stones. If the stones get stuck in the mixing drum 94, the mixing arm 96 or the transmission means 95 may suffer damage.

FIG. 3 shows another conventional concrete mixer capable of mixing concrete in a compulsory and rapid manner. One end of the motor is provided with a mixing rod 97. The outer edge of the mixing rod 97 is provided with blades 98. An operator holds the mixing rod 97 for mixing the concrete. Alternatively, a hoist is used for lifting or lowering the mixing rod 97 for mixing the concrete. However, such a conventional concrete mixer needs to put the cement, sand or stone in the mixing drum. Then, the mixing end of the mixing rod 97 is put in the mixing drum. However, the blades cannot mix the lower portion of the concrete smoothly. Thus, such a conventional concrete mixer is suitable for mixing mortar having more water. Alternatively, an additional punching rod is used to punch a deep hole in the bottom of the mixing drum, so that the mixing rod 97 can be disposed in the bottom of the mixing drum for mixing the lower portion of the concrete. Thus, it is inconvenient in use and has a poor efficiency. Further, the quality of the mixed concrete is deteriorated.

FIG. 4 shows another conventional concrete mixer. The underside of a mixing drum 99 is provided with a transmission means (not shown). The interior of the mixing drum 99 is provided with a stirring piece 100 driven by the transmission means. A connecting rod 101 is connected to an automobile. When the transmission means is operated, the automobile drags the mixer to move and thus causes the stirring piece to rotate. Thus, such a conventional concrete mixer has a high cost and cannot mix concrete at a fixed site, so that there is still room for improvement.

### SUMMARY OF THE INVENTION

An objective of the present invention is to provide a centrifugal concrete mixer. The concrete mixer can rapidly rotate a stirring piece to generate a centrifugal force to indirectly mix the concrete and mortar. In this way, the mixing efficiency and the quality of mixed concrete are improved. The mixing area of the stirring piece is reduced. The problem that the stirring piece get stuck and suffer damage in the mixing drum due to a low rotation speed or a large contact area with the concrete is solved.

### BRIEF DESCRIPTION OF THE DRAWINGS

FIG. 1 is a schematic view showing the operation of a first kind of conventional mixer;

FIG. 2 is a schematic view showing the external appearance of a second kind of conventional mixer;

FIG. 3 is a schematic view showing a third kind of conventional mixer;

FIG. 4 is a schematic view showing the external appearance of a fourth kind of conventional mixer;

FIG. 5 is a schematic view showing the external appearance of a first embodiment of the present invention;

FIG. 6 is an exploded view showing the first embodiment of the present invention;

FIG. 7 is a schematic view showing an operating state of the first embodiment of the present invention;

FIG. 8 is a partially enlarged view showing the operating state of the first embodiment of the present invention;

FIG. 9 is a schematic view showing the another operating state of the first embodiment of the present invention;

FIG. 10 is an assembled cross-sectional view showing that a mixing drum of the first embodiment of the present invention is made of plastic materials;

FIG. 11 is an assembled cross-sectional view showing a second embodiment of the present invention;

FIG. 12 is a schematic view showing that the power device is an engine powered by gasoline and steam; and

FIG. 13 is a schematic view showing that a base frame is received in a mixing drum according to the present invention.

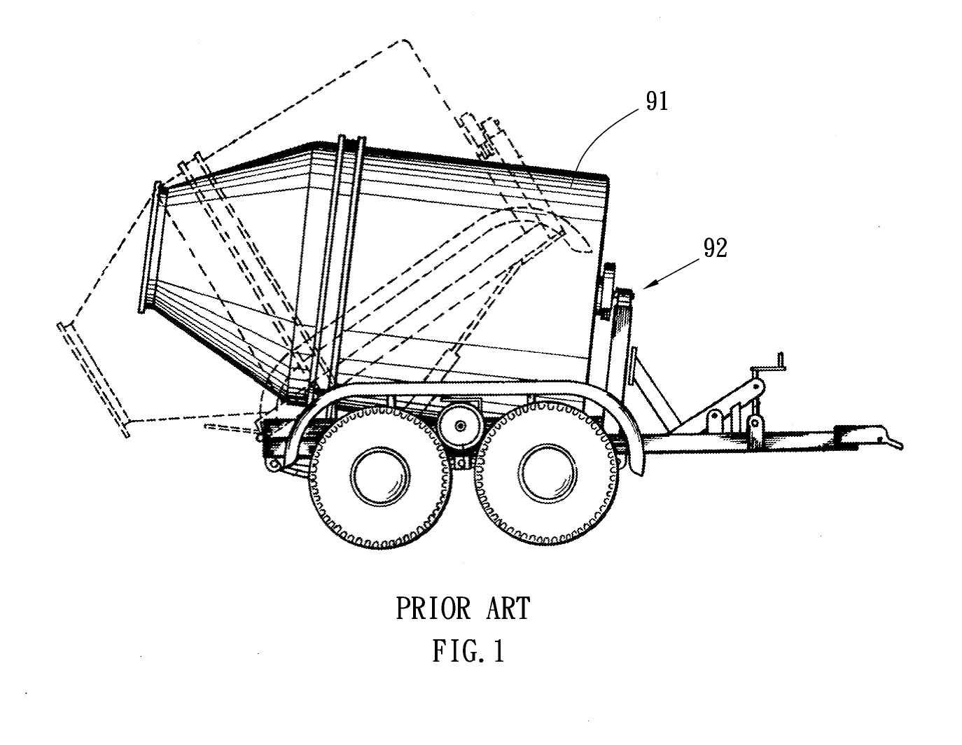

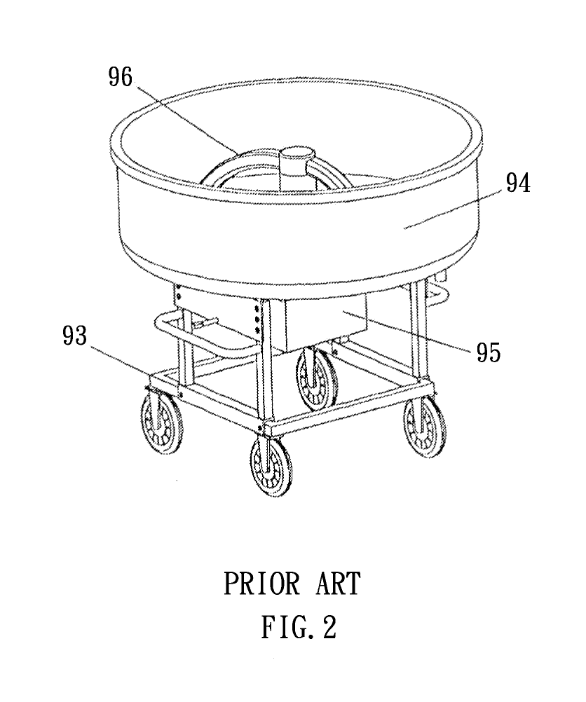

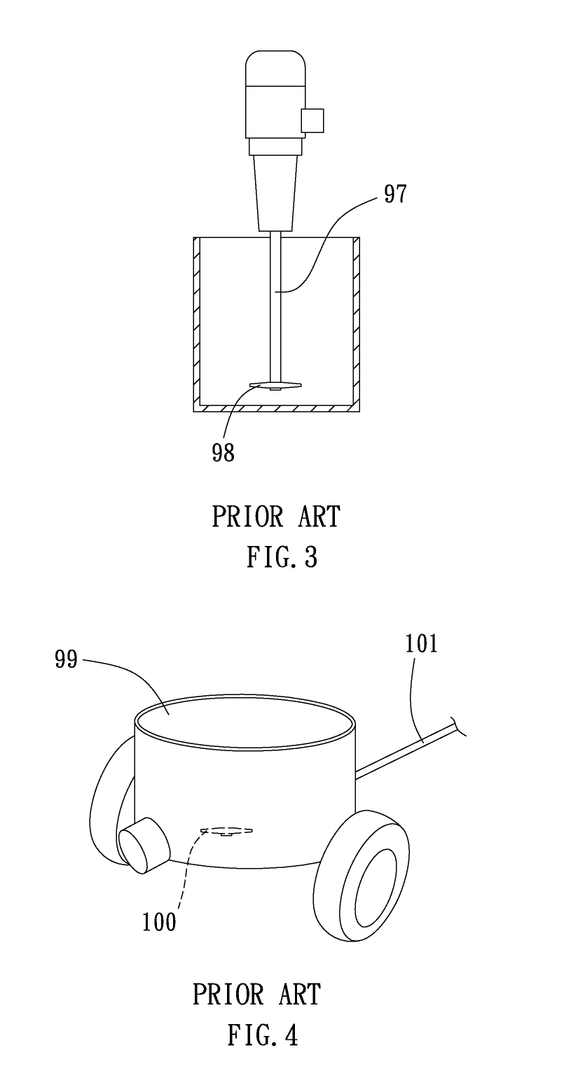

### DETAILED DESCRIPTION OF THE INVENTION

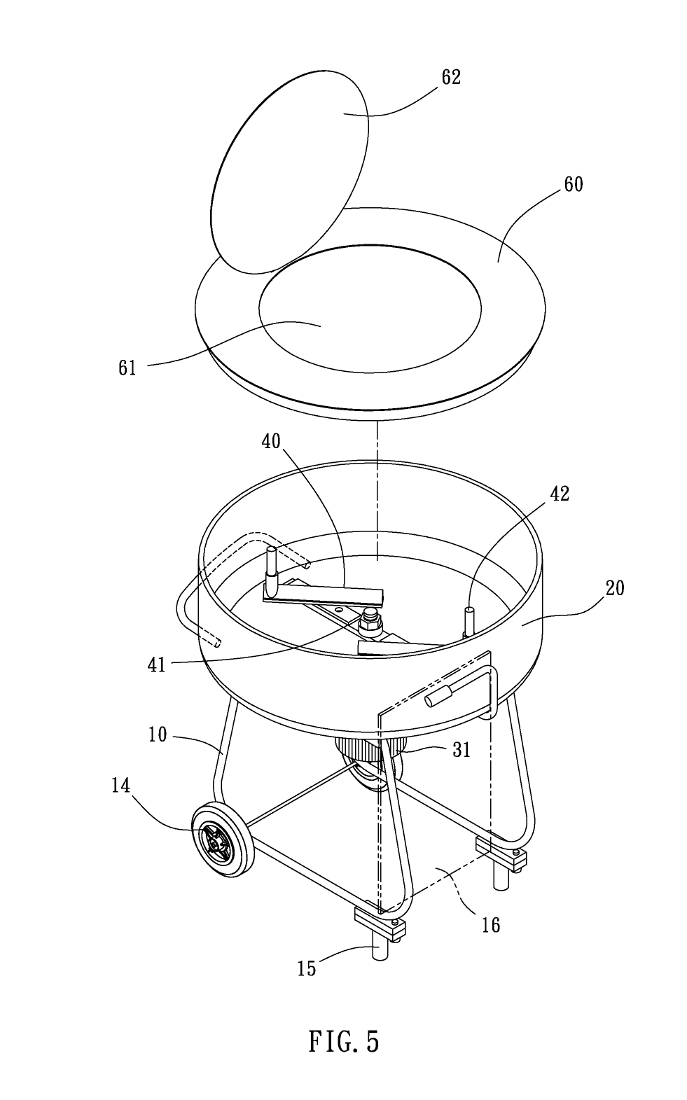

Please refer to FIGS. 5 to 13. The present invention provides a centrifugal concrete mixer, which includes a base frame 10, a mixing drum 20, a transmission means 30, and two stirring pieces 40.

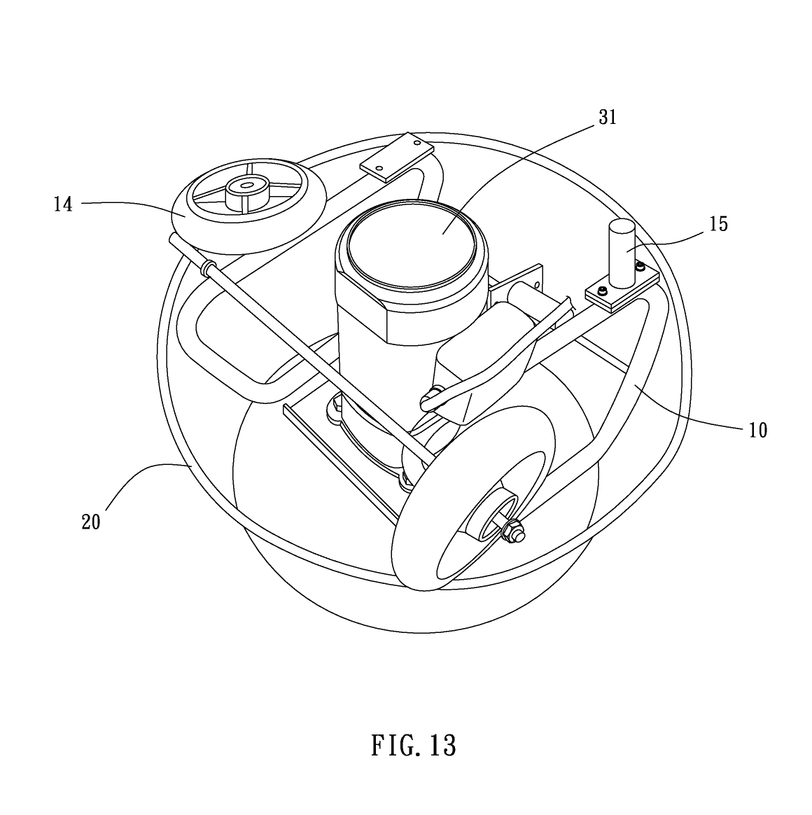

The base frame 10 is formed as a frame for supporting the mixing drum 20 and the transmission means 30. The bottom of the base frame 10 is provided with wheels 14 and legs 15. Two opposite ends of one side of the base frame 10 are provided with a hanging post 11 respectively for allowing the mixing drum 20 to be rotatably hung or stored thereon. The legs 15 are fixed to the base frame 10 by screws, so that it is convenient to assemble/disassemble the legs 15 and store them in the mixing drum 20 (as shown in FIG. 13). One side of the base frame 10 is provided with a blocking plate 16 for preventing mortar in the mixing drum 20 from splashing the transmission means 30.

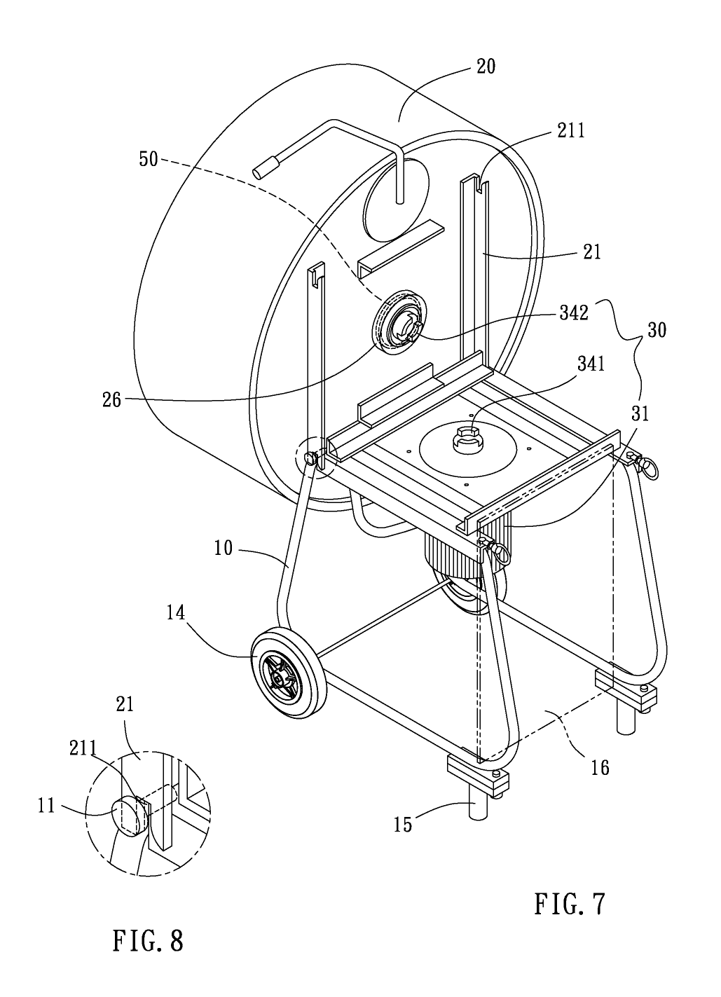

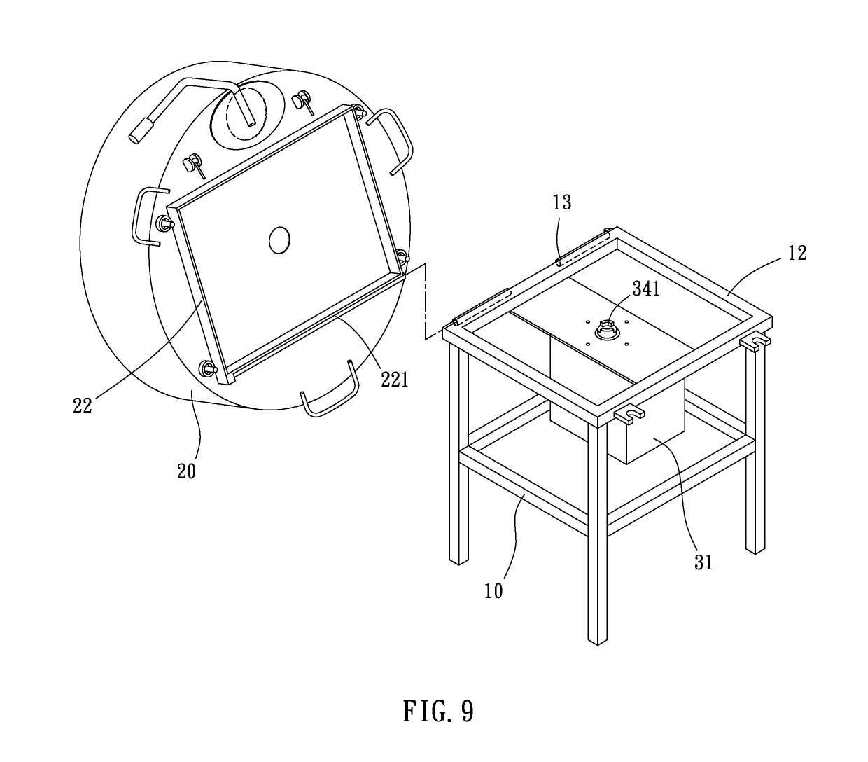

The mixing drum 20 is made of metallic or plastic materials. The interior of the mixing drum 20 is hollow. One end of the transmission means 30 penetrates the center of the mixing drum 20 to be connected to the stirring pieces 40. A waterproof unit 50 is provided between the transmission means 30 and the mixing drum 20. When the mixing drum 20 is made of metallic materials, the bottom of the mixing drum 20 is provided with two opposite frame beams 21. At least one end surface of each frame beam 21 is formed with a locking trough 211, so that the mixing drum 20 can be hung on the base frame 10 by engaging the two locking troughs 211 with the hanging posts 11 respectively as shown in FIGS. 7 and 8.

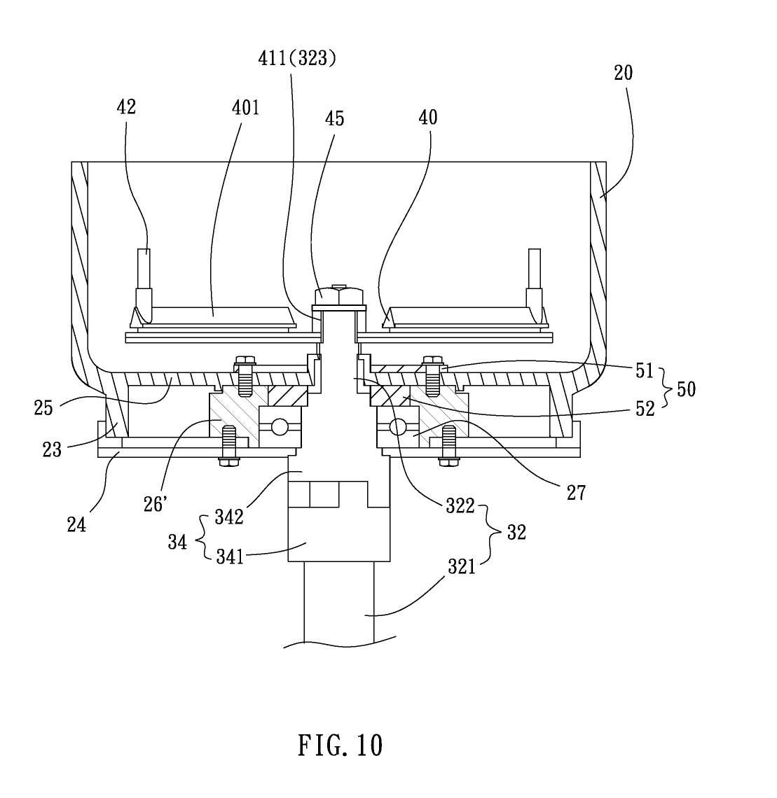

Alternatively, as shown in FIG. 9, the upper end of the base frame 10 is provided with a rack plate 12 on which the transmission means 30 is fixed. An outer edge of the rack plate 12 is fixedly provided with a plurality of connecting tubes 13. The bottom surface of the mixing drum 20 is provided with a rotatable plate 22. An outer surface of the rotatable plate 22 is provided with a pivotal rod 221 corresponding to the connecting tubes 13. When the pivotal rod 221 of the mixing drum 20 is disposed in the connecting tubes 13 of the rack plate 12, the mixing drum 20 can be hung on the rack plate 12 with a 90-degree rotation. By this arrangement, even a large-sized mixing drum 20 can be separated from the rack plate 12 without using the hanging posts 11.

As shown in FIG. 5, the upper edge of the mixing drum 20 is provided with a cover 60. The outer periphery of the cover 60 covers the edge of the mixing drum 20. The central region of the cover 60 is provided with a feeding opening 61. A door 62 is pivotally provided on the edge of the feeding opening 61 for preventing the mortar from spilling out of the cover 60. On the other hand, the feeding opening 62 and the door 62 facilitate the feeding of raw materials of the concrete into the mixing drum 20.

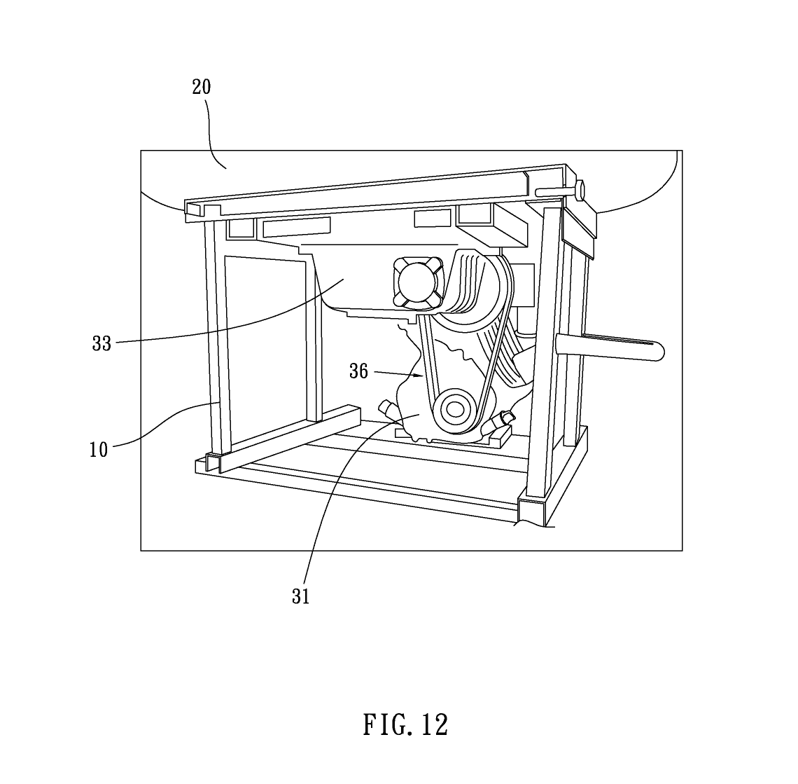

The transmission means 30 is constituted of a power device 31 and a transmission shaft 32. The power device 31 drives the stirring piece 40 to rotate at a speed of 100 rpm to 1000 rpm. The power device 31 may be a motor powered by alternating current (AC) or direct current (DC) of a battery. Alternatively, as shown in FIG. 12, the power device 31 may be an engine powered by gasoline or diesel. For example. the power device 31 in a form of engine employs a belt pulley set 36 to drive a gear box 33 to rotate, thereby driving the transmission shaft 32 to rotate accordingly. Next, corresponding to the connecting positions between the mixing drum 20 and the base frame 10, the transmission shaft 32 is divided into two sections including a primary transmission shaft 321 and an auxiliary transmission shaft 322. A clutch 34 constituted of a first clutch block 341 and a second clutch block 342 is provided between the primary transmission shaft 321 and the auxiliary transmission shaft 322. By this arrangement, the mixing drum 20 can be separated from the power device 31 to be hung on the base frame 10 with a 90-degree rotation.

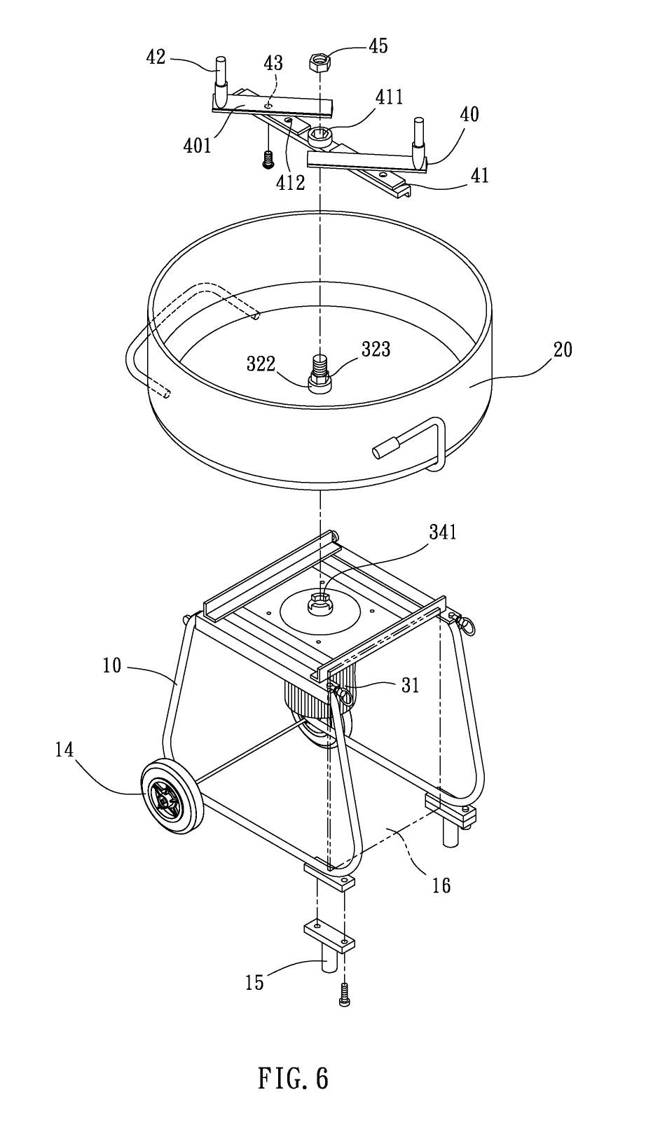

The two stirring pieces 40 are connected to the transmission shaft 32 via a fixing plate 41. The fixing plate 41 is formed with a non-circular transmission hole 411. In the present embodiment, the transmission hole 411 is a hexagonal hole as shown in FIG. 6, so that a corresponding hexagonal transmission portion 323 formed on one end of the transmission shaft 32 can be connected therein for transmitting kinetic energy. A fixing piece 45 is provided at an end of the transmission shaft 32 for fixation. The fixing piece 45 may be a nut, screw, pin bolt, machine key or C-shaped retainer. The stirring piece 40 is formed as a plate. The outer side surface of the stirring piece 40 relative to its rotating direction is formed into an inclined surface 401, so that the stirring piece 40 can be rapidly driven by the transmission means 30. The end of the stirring piece 40 is provided with an auxiliary stirring portion 42 to face the inner surface of the mixing drum 20. As for the fixation of each stirring piece 40, the fixing plate 41 is formed a plurality of penetration holes 412 at positions corresponding to both sides of the transmission hole 321. The rear surface of each stirring piece 40 is formed with a plurality of screw holes 43. By this arrangement, each stirring piece 40 can be fixed to the fixing plate 41 by screws in different angular orientations.

The waterproof unit 50 is an elastic gasket. If the mixing drum 20 is made of metallic materials, a bearing seat 26 is provided at a position corresponding to the auxiliary transmission shaft 322 of the transmission shaft 32 penetrating the bottom of the mixing drum 20. The waterproof unit 50 is provided in the bearing seat 26 as shown in FIG. 7.

Further, as shown in FIG. 10, if the mixing drum 20 is made of plastic materials, a supporting guard 24 is provided to cover the outer edge of the bottom of the mixing drum 20. Another bearing seat 26′ is provided between the supporting guard 24 and the outer edge of a bottom plate 25 of the mixing drum 20. The waterproof unit 50 is provided on both inner and outer surfaces of the bottom plate 25. The waterproof unit 50 is constituted of a first leakage-proof piece 51 and a second leakage-proof piece 52. The first leakage-proof piece 51 is provided in the mixing drum 20 and penetrated by the auxiliary transmission shaft 322 of the transmission shaft 32. The second leakage-proof piece 52 is provided on the outer surface of the bottom plate 25 and penetrated by the primary transmission shaft 321 of the transmission shaft. The underside of the second leakage-proof piece 52 is provided with a bearing 27. With the waterproof unit 50, an excellent waterproof effect can be achieved when the transmission shaft 32 penetrates into the mixing drum 20.

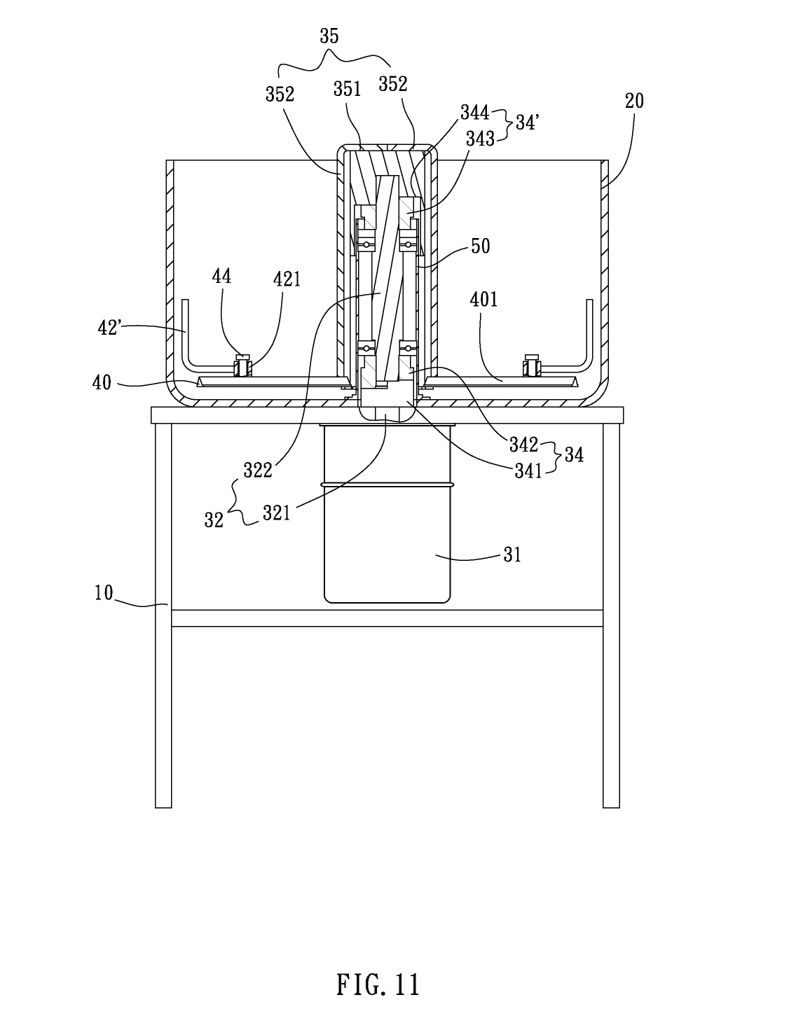

Further, FIG. 11 shows the structure of the transmission means 30 and the waterproof unit 50 according to another embodiment. In the present embodiment, similarly, the upside of the base frame 10 is provided with the mixing drum 20, and the underside of the base frame 20 is provided with the transmission means 30. Two stirring pieces 40 are driven by the transmission means 30 to rotate in the mixing drum 20. The difference between the present embodiment and the previous embodiment is described as follows.

In addition to the power device 31 and the transmission shaft 32, the transmission means 30 includes a connecting piece 35 provided at the tip end of the transmission shaft 32. The center of the connecting piece 35 is provided with a cap portion 351. The transmission shaft 32 is also constituted of a primary transmission shaft 321 and an auxiliary transmission shaft 322. The clutch 34 constituted of a first clutch block 341 and a second clutch block 342 is provided between the primary transmission shaft 321 and the auxiliary transmission shaft 322. Another clutch 34′ is provided between the top end of the auxiliary transmission shaft 322 and the cap portion 351. The clutch 34′ includes a third clutch block 343 provided at the top end of the auxiliary transmission shaft 322, and a fourth clutch block 344 formed on the inner edge of the cap portion 351. By this structure, the transmission shaft 32 can drive the connecting piece 35 to rotate.

Further, the connecting rod 35 has a plurality of sub-rods 352 extending downwardly from two opposite sides of the outer edge of the cap portion 351. The stirring piece 40 is fixed to the lower portion of the sub-rod 352. A suitable gap exists between the sub-rod 352 and the waterproof unit 50 for preventing the stones from getting stuck therein.

The stirring piece 40 is also formed into a plate. The outer surface of the stirring piece 40 relative to its rotating direction is formed into an inclined surface 401. The outer end of the stirring piece 40 is pivotally connected to an auxiliary stirring portion 42′ via a positioning piece 44. The auxiliary stirring portion 42′ erects on the stirring piece 40 for increasing the effect of mixing concrete. The other end of the stirring piece 40 is provided with a shaft sleeve 421, whereby the positioning piece 44 can penetrate the shaft sleeve 421 to be pivotally connected to the stirring piece 40.

The waterproof unit 50 is a hollow sleeve. The bottom end of the waterproof unit 50 is fixedly connected to the bottom of the mixing drum 20 which the transmission shaft 32 penetrates. The inner edge of the waterproof unit 50 is penetrated by the transmission shaft 32. The top end of the waterproof unit 50 is assembled with the connecting piece 35.

With the above constituents, the transmission means 30 rapidly drives the stirring piece 40 to rotate at a speed of 100 rpm. The inclined surfaces 401 and the auxiliary stirring portions 42, 42′ of the stirring pieces 40 can generate a centrifugal force during their rotation, which indirectly pushes and stirs the mortar containing stones. In this way, the efficiency in mixing concrete and the quality of mixed concrete are improved. Further, the stirring piece 40 can be taken off the mixing drum 20 easily, so that it is convenient to clean the mixing drum 20.

What is claimed is:

1. A centrifugal concrete mixer, including a base frame, a mixing drum provided on the base frame, and a transmission means coupled to the base frame, the transmission means driving a transmission shaft to rotate via a power device, characterized in that:
the power device rotates at a speed of 60 rpm to 600 rpm, one end of the transmission shaft penetrates into the mixing drum, a waterproof unit is provided between the transmission shaft and the mixing drum, at least one stirring piece is provided on an outer edge of the transmission shaft in the mixing drum, the stirring piece is connected to the transmission shaft via a fixing plate, the fixing plate is formed with a non-circular transmission hole, one end of the transmission shaft penetrates into the transmission hole to be connected therein for transmitting kinetic energy, a fixing piece is provided at an end of the transmission shaft for fixation, the stirring piece is formed into a plate, an outer surface of the stirring piece relative to its rotating direction is formed into an inclined surface, the inclined surface of the stirring piece is capable of generating a centrifugal force when the stirring piece is driven by the transmission means to rotate at a high speed, thereby mixing the concrete containing gravel.

2. The centrifugal concrete mixer according to claim 1, wherein the fixing plate is formed with a plurality of penetration holes at positions corresponding to both sides of the transmission hole, a rear surface of each stirring piece is formed with a plurality of screw holes, so that the stirring piece can be fixed on the fixing plate by screws at different angular orientations.

3. The centrifugal concrete mixer according to claim 1, wherein an outer end of the stirring piece is formed with an auxiliary stirring portion for increasing the effect of mixing the concrete.

4. The centrifugal concrete mixer according to claim 1, wherein a supporting guard is provided to cover an outer edge of the bottom of the mixing drum, a bearing seat is provided between the supporting guard and an outer edge of a bottom plate of the mixing drum, the waterproof unit constituted of a first leakage-proof piece and a second leakage-proof piece is provided on inner and outer surfaces of the bottom plate respectively, the first leakage-proof piece is provided in the mixing drum, penetrated by the transmission shaft and located below the stirring piece, the second leakage-proof piece is provided on the outer surface of the bottom plate and penetrated by the transmission shaft, the underside of the second leakage-proof piece is provided with a bearing.

5. The centrifugal concrete mixer according to claim 1, wherein the fixing piece is a nut, a screw, pin bolt, machine key or a C-shaped retainer.

6. A centrifugal concrete mixer, including a base frame, a mixing drum provided on the base frame, and a transmission means coupled to the base frame, the transmission means driving a transmission shaft to rotate via a power device, characterized in that:
the power device rotates at a speed of 60 rpm to 600 rpm, one end of the transmission shaft penetrates the mixing drum, a waterproof unit is provided between the transmission shaft and the mixing drum, at least one stirring piece is provided on an outer edge of the transmission shaft in the mixing drum, the waterproof unit is hollow sleeve, one end of the waterproof unit is fixedly connected to the bottom of the mixing drum where the transmission shaft penetrates, a top end of the transmission shaft is connected to the stirring piece via a connecting piece, a center of the connecting piece is provided with a cap portion for connecting the transmission shaft, a plurality of sub-rods extend downwardly from the outer periphery of the connecting piece to the bottom of the mixing drum, the stirring piece is fixedly provided on the sub-rod, the stirring piece is formed into a plate, an outer surface of the stirring piece relative to its rotation direction is formed into an inclined surface, the inclined surface of the stirring piece is capable of generating a centrifugal force when the stirring piece is driven by the transmission means to rotate at a high speed, thereby mixing the concrete containing stones.

7. The centrifugal concrete mixer according to claim 6, wherein an outer end of the stirring piece is pivotally provided with an auxiliary stirring portion via a positioning piece, the auxiliary stirring portion erects on the stirring piece for increasing the effect of mixing the concrete, the other end of the stirring piece is provided with a sleeve for allowing the positioning piece to penetrate therein.

8. The centrifugal concrete mixer according to claim 1, wherein the power device is a motor powered by alternating current.

9. The centrifugal concrete mixer according to claim 1, wherein the power device is a motor powered by direct current of a battery.

10. The centrifugal concrete mixer according to claim 1, wherein the power device is an engine powered by gasoline or diesel.

11. The centrifugal concrete mixer according to claim 1, wherein the power device of the transmission means is fixed to a rack plate, the rack plate is fixed to the upper edge of the base frame, an outer edge of the rack plate is fixedly provided with a plurality of connecting tubes, a rotatable plate is provided on the bottom surface of the mixing drum, the rotatable plate is provided with a pivotal rod corresponding to the outer surface of the connecting pieces, the transmission shaft is divided into two sections including a primary transmission shaft and an auxiliary transmission shaft at connecting positions between the mixing drum and the base frame, a clutch constituted of a first clutch block and a second clutch block is provided between the primary transmission shaft and the second transmission shaft, the mixing drum is able to be separated from the power device, the pivotal rod of the mixing drum penetrates into the connecting tubes of the rack plate, so that the mixing drum can be put on the base frame with a 90-degree rotation for better cleaning, or be separated for transportation and storage.

12. The centrifugal concrete mixer according to claim 1, wherein the power device of the transmission means is fixed to a rack plate, the rack plate is fixed to an upper edge of the base frame, two opposite ends of one side of the rack plate are provided with a hanging post respectively, the bottom surface of the mixing drum is provided with two facing frame beams, at least one end of each frame beam is formed with a locking trough, the transmission shaft is divided into two sections including a primary transmission shaft and an auxiliary transmission shaft at connecting positions between the mixing drum and the base frame, a clutch constituted of a first clutch block and a second clutch block is provided between the primary transmission shaft and the second transmission shaft, the mixing drum is able to be separated from the power device, the locking troughs of the mixing drum are engaged with the hanging posts of the rack plate, so that the mixing drum can be put on the base frame with a 90-degree rotation for better cleaning, transportation and storage.

13. The centrifugal concrete mixer according to claim 1, wherein an upper edge of the mixing drum is provided with a cover, an outer periphery of the cover covers the edge of the mixing drum, a central region of the cover is provided with a feeding opening, a door is pivotally connected to the feeding opening for preventing mortar from spilling out of the mixing drum.

14. The centrifugal concrete mixer according to claim 6, wherein the power device is a motor powered by alternating current.

15. The centrifugal concrete mixer according to claim 6, wherein the power device is a motor powered by direct current of a battery.

17. The centrifugal concrete mixer according to claim 6, wherein the power device is an engine powered by gasoline or diesel.

18. The centrifugal concrete mixer according to claim 6, wherein the power device of the transmission means is fixed to a rack plate, the rack plate is fixed to the upper edge of the base frame, an outer edge of the rack plate is fixedly provided with a plurality of connecting tubes, a rotatable plate is provided on the bottom surface of the mixing drum, the rotatable plate is provided with a pivotal rod corresponding to the outer surface of the connecting pieces, the transmission shaft is divided into two sections including a primary transmission shaft and an auxiliary transmission shaft at connecting positions between the mixing drum and the base frame, a clutch constituted of a first clutch block and a second clutch block is provided between the primary transmission shaft and the second transmission shaft, the mixing drum is able to be separated from the power device, the pivotal rod of the mixing drum penetrates into the connecting tubes of the rack plate, so that the mixing drum can be put on the base frame with a 90-degree rotation for better cleaning, or be separated for transportation and storage.

19. The centrifugal concrete mixer according to claim 6, wherein the power device of the transmission means is fixed to a rack plate, the rack plate is fixed to an upper edge of the base frame, two opposite ends of one side of the rack plate are provided with a hanging post respectively, the bottom surface of the mixing drum is provided with two facing frame beams, at least one end of each frame beam is formed with a locking trough, the transmission shaft is divided into two sections including a primary transmission shaft and an auxiliary transmission shaft at connecting positions between the mixing drum and the base frame, a clutch constituted of a first clutch block and a second clutch block is provided between the primary transmission shaft and the second transmission shaft, the mixing drum is able to be separated from the power device, the locking troughs of the mixing drum are engaged with the hanging posts of the rack plate, so that the mixing drum can be put on the base frame with a 90-degree rotation for better cleaning, transportation and storage.

20. The centrifugal concrete mixer according to claim 6, wherein an upper edge of the mixing drum is provided with a cover, an outer periphery of the cover covers the edge of the mixing drum, a central region of the cover is provided with a feeding opening, a door is pivotally connected to the feeding opening for preventing mortar from spilling out of the mixing drum.
